(19) United States
(12) Patent Application Publication
(10) Pub. No.: US 2007/0285839 A1
(43) Pub. Date: Dec. 13, 2007

(54) Perpendicular magnetic recording medium and method of manufacturing the same

(75) Inventors: Hiroyuki Suzuki, Kanagawa (JP); Reiko Arai, Kanagawa (JP); Hiroyuki Matsumoto, Kanagwa-ken (JP); Masayoshi Shimizu, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., AZ Amsterdam (NL)

(21) Appl. No.: 11/804,197

(22) Filed: May 16, 2007

(30) Foreign Application Priority Data
May 19, 2006 (JP) 2006-140742

(51) Int. Cl. G11B 5/74

(52) U.S. Cl. 360/131

(57) ABSTRACT

Embodiments of the present invention improve the production efficiency of a perpendicular recording medium while ensuring the scratch resistance thereof. In order to realize high production stability in the high speed production of perpendicular recording media, a target is not provided with a texture of a low melting point or the ratio thereof is decreased. Thus according to one embodiment of the present invention, upon forming a layer having an element of a low melting point in the constituent layers of a perpendicular recording medium, a target can be made using an alloy powder previously formed of an intermetallic compound having a melting point higher than 660° C., thereby preventing thermal deformation.

### CROSS-REFERENCE TO RELATED APPLICATION

The instant nonprovisional patent application claims priority to Japanese Application No. 2006-140742 filed May 19, 2006 and incorporated by reference in its entirety herein for all purposes.

### BACKGROUND OF THE INVENTION

Hard disk devices used as an external recording device of an information processing apparatus such as computers, have been increased in capacity and reduced in the size, and the application use thereof, such as incorporation into home electronic products, has been remarkably extended. Due to its wide spread application uses, there is a demand for the mass production of high performance perpendicular magnetic recoding media.

Japanese Laid-Open Patent No. 2005-302238 (“Patent Document 1”) discloses a perpendicular magnetic recording medium formed with a perpendicular recording layer on a substrate via a soft magnetic under layer. In the medium, an amorphous layer or a microcrystalline layer is formed between the substrate and the soft magnetic under layer. The soft magnetic under layer has a first amorphous soft magnetic layer, a second amorphous soft magnetic layer, and a non-magnetic layer formed between the first amorphous soft magnetic layer and the second amorphous soft magnetic layer. The first amorphous soft magnetic layer and the second amorphous soft magnetic layer have a monoaxial anisotropy provided in the radial direction of the substrate and are coupled anti-ferromagnetically. The non-magnetic layer or the microcrystalline layer includes alloys containing at least two or more of metals in the group consisting of Ni, Al, Ti, Ta, Cr, Zr, Co, Hf, Si, and B.

For a sputtering target for use in opto-magnetic recording, which is a sintering resistant material at a good productivity and controlling the composition thereof, Japanese Laid-Open Patent No. 1994-306414 (“Patent Document 2”) discloses a structure of using an alloy powder containing at least one rare earth element such as Sm, Nd, Cd, Th, Dy, Ho, Tm, and Er, a predetermined amount of Sb and a predetermined amount of Te as a starting powder, preferably, an atomized alloy powder quenched by atomization from a molten state and sintering the same by an electric discharge plasma method.

Japanese Laid-Open Patent No. 2002-363615 (“Patent Document 3”) discloses a method of manufacturing a sputtered Co type target material, which has a low magnetic permeability and is used in a magnetic recording medium, enabling manufacture of the high performance thin film without deteriorating the magnetic characteristics of the thin film, The method includes the steps of filling and sealing an atomized powder of a Co—Cr—Ta type alloy into a metal vessel, solidifying and molding the atomized powder in a die for pressure/compression application by applying pressure to the atomized powder at a high temperature and high pressure, applying a heat treatment for lowering the permeability at a temperature in a range from 800 to 1250° C. in the middle of cooling, cooling and then machining the same into a predetermined shape.

### BRIEF SUMMARY OF THE INVENTION

Embodiments in accordance with the present invention improve the production efficiency of a perpendicular recording medium while ensuring the scratch resistance thereof. To realize high production stability in the high speed production of perpendicular recording media, a target should not be provided with a texture of a low melting point or the ratio thereof is decreased.

According to the particular embodiment of the present invention disclosed in FIG. 1, upon forming a layer having an element of a low melting point in the constituent layers of a perpendicular recording medium 100, a target is made using an alloy powder previously formed of an intermetallic compound having a melting point higher than 660° C., thereby preventing thermal deformation.

### BRIEF DESCRIPTION OF THE DRAWINGS

FIG. 1 is a cross-sectional view showing the structure of a perpendicular recording medium according to a first embodiment of the present invention.

FIG. 2 is a cross-sectional view showing the structure of the perpendicular recording medium of the first embodiment.

FIG. 3 is a view showing a target used upon forming a perpendicular magnetic recording medium of comparative example 1.

FIG. 4 shows an apparatus upon manufacturing a perpendicular recording medium according to the present embodiment.

### DETAILED DESCRIPTION OF THE INVENTION

Embodiments in accordance with the present invention relate to a perpendicular magnetic recording medium and a method of manufacturing the same.

The following issues may arise in the improvement for the production efficiency of perpendicular recording media. In a perpendicular recording medium having a soft magnetic under layer, a structure of a non-magnetic under layer between a substrate and a soft magnetic under layer is important for ensuring the scratch resistance. As a result of a study on the materials and improvement for the production efficiency, it has been found that a target deforms as shown in FIG. 3.

As the tact efficiency of the target is improved, consumption speed of the sputtering target is increased, thereby increasing the frequency of exchanging targets. The time for exchanging the targets can be shortened by clamping a target to a backing plate using a screw without metal bonding by utilizing indium or gallium to the backing plate for cooling the target. However, also in such a case, since the cooling efficiency of the target lowers relatively in the case of clamping the target to a backing plate using a screw, compared with a metal-bonded target upon attaining a great amount of films in a short time by charging a high power, a problem of target deformation sometimes occurs as the production efficiency is enhanced.

Accordingly, an object of embodiments of the present invention is to improve the production efficiency of a perpendicular recording medium while ensuring the scratch resistance thereof.

An outline for embodiments disclosed in the present application is briefly described as below.

A perpendicular magnetic recording medium has a substrate, an adhesion layer, an intermediate layer, a perpendicular recording layer, and a protective layer. The adhesion layer is formed by sputtering using an intermetallic compound formed of two or more kinds of metal elements having different melting points and is disposed between the intermediate layer and the substrate. The intermetallic compound has a melting point higher than the metal element having the lowest melting point among the two or more kinds of metal elements which have different melting points. It is preferred to use an atomizing method upon forming the intermetallic compound and be subjected to HIP subsequently.

According to embodiments of the present invention, it is possible to provide a method of manufacturing a perpendicular magnetic recording medium while reducing troubles in the production caused by deformation of targets upon mass production at a high speed, and provide a perpendicular magnetic recording medium with excellent productivity.

Particular embodiments are described below with reference to the drawings.

### FIRST EMBODIMENT

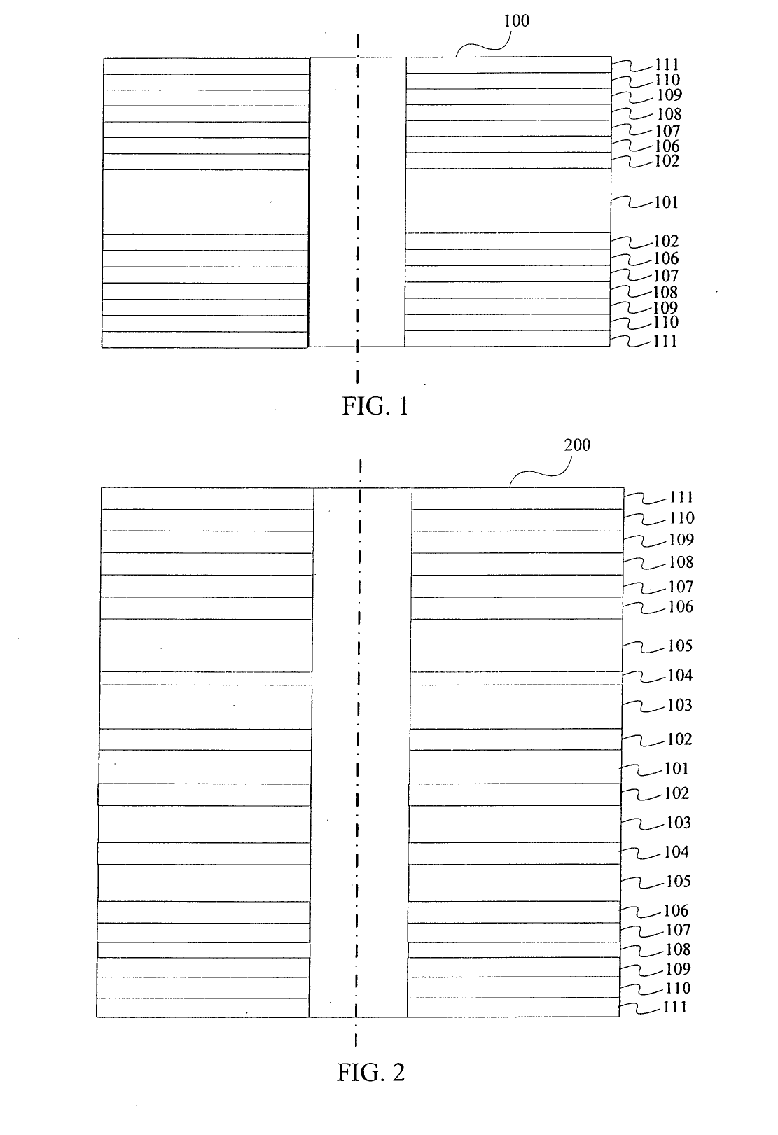

FIG. 1 shows a cross-section of a perpendicular recording medium 100 according to a first embodiment of the present invention. The perpendicular recording medium 100 has, on a substrate 101, a non-magnetic under layer 102, non-magnetic intermediate layers 106, 107, 108, a recording layer 109, a protective layer 110, and a lubrication layer 111. The non-magnetic under layer 102 is disposed between the intermediate layer 106 and the substrate 101 to ensure adhesion between both of the layers. The non-magnetic under layer 102 is formed by combining two or more of metal elements having different melting points and by sputtering using an intermetallic compound having a melting point higher than that of a metal element having the lowest melting point among the two or more kinds of metal elements having different melting points. This can suppress the deformation of a target, decrease the cycle of exchanging targets, resulting in improving the productivity. In a perpendicular recording medium, it has been considered a problem that the scratch resistance is poor compared with an in-plane recording medium. To ensure the scratch resistance, a function of the non-magnetic under layer is important. As the non-magnetic under layers, a material containing Al and at least one or more of metals in the group consisting of Ti, Ni, Ta, Cr, Zr, Co, and Hf, or a material containing Sb and at least one or more of metals in the group consisting of Ti, Nb, Cr, Zr, Co, and Y are used. Materials having a low melting point such as Al and Sb constitute an intermetallic compound in combination with the metal having a high melting point, thereby having a melting point higher than those of Al, Sb, etc. To form the intermetallic compound, a gas atomizing method using an inert gas, Ar, is used. The atomizing method means a method of heating alloy components to dissolve them; causing the molten alloy to flow from a nozzle formed in the bottom of a turn-dish to form a fine stream of the molten alloy; blowing a jet fluid to the stream of the molten alloy from the periphery thereof; powdering the molten alloy stream flowing down by the energy of the jet fluid; coagulating formed droplets while dropping them; and forming an alloy powder. Concentration of the metal element having low melting point is made uniform over the entire surface by atomization. Thus, the surface state of the target surface can be stabilized chemically. Deformation of the target causes a problem in a metal element having a melting point of 660° C. or lower. The reason for this is described. In a sputtering target containing a single element having a melting point lower than the temperature of 660° C., a temperature of 30% to 50% of 660° C. (which means 198° C. to 330° C.) corresponds to the crystallizing temperature of the element, the target tends to be deformed in the case where the heat generation temperature of the target exceeds the re-crystallization temperature.

The adhesion is improved by using the constituent elements described above since the alloy components having a low melting point tend to potentially form an intermetallic compound, and since the adhesion strength is improved because the surface is active at the boundary with the substrate 101 or the non-magnetic intermediate layer 106. In other layers, since there was less necessity for improving the adhesion strength by intentionally decreasing the crystallinity, materials having low melting points were not used.

Particularly, use of AlTi as the non-magnetic under layer is preferred since improvement can be attained for the stress relaxation, scratch resistance, and the corrosion resistance. In a case of sputtering AlTi by using an alloy powder formed by mixing and sintering metal elements used usually as a target, a texture having low melting point and high Al concentration remains in the target and the target deforms from a portion of low melting point due to the heat generation during sputtering. On the other hand, it has been found according to the study of embodiments of the present invention, that a structure in which the additive element concentration of Ti is high and the Al concentration is relatively lower, is chemically active and tends to cause adsorption of a residual gas on the surface by the vacuum back pressure. Particularly, in a case where the tact is severe (about 750 to 1200 media per one hour), the target deforms remarkably. For example, FIG. 3 is a photograph of a target about one hour after from the start of production when continuously producing media by using an (Al—49.83 at. % Ti)—140 wt.ppm Fe 490 wt.ppm O—37 wt.ppm C—27 wt.ppm N target as a target for forming the non-magnetic under layer 102 while producing 750 media per one hour. The target is already deformed. As a result, the magnetic recording medium can no longer be transported and it is necessary to exchange the target to continue the production.

For the deformation, it is considered that the melting point of the texture of an Al solid solution having an fcc structure of high Al concentration and constituting the target, is about 660° C., and the portion is liable to be crystallized and deforms by the heat generation in the high speed film formation. In view of the above, an intermetallic compound having a melting point higher than the Al melting point of 660° C. was prepared, and the intermetallic compound was subjected to HIP (Hot Isostatic Pressing) so as to attain a desired composition to reach a structure forming the target. It is noted that in the target which was sintered without atomizing Al and Ti, the target density was as low as 3.60, and concentrations of iron, carbon, and nitrogen was also low.

On the other hand, in the case of preparing an atomized powder as in the present embodiment, the target includes Fe of 300 wt.ppm or more in the step of preparing or in the step of classifying the atomized powder. Further, as a result of atomization, oxygen, carbon, and nitrogen are included as impurities. The concentration of Fe contained in the target may be low for maintaining the easy control of film thickness in the case where it is contained in other constituent layers. Then, when an alloy powder having a composition corresponding to an intermetallic compound in which the concentration of an element M to be added to Al is decreased is previously formed and classified, and then the alloy powder is mixed with the single element M to form a target of an aimed target composition, since the frequency of classification can be decreased relatively, the concentration of iron and the concentration of oxygen can be decreased together. However, also in this case, Fe of 300 wt.ppm or more is included, other than the metal element constituting the intermetallic compound, in the adhesion layer as a result of atomization.

Since the intermetallic compound can be easily prepared latently when Ti at high concentration is contained as the non-magnetic under layer 102, the crystal grains are refined and the adhesion strength is increased. In addition, an element in place of titanium (Ti), Ni, Ta, Cr, Zr, Co, Hf, etc. may be substituted, or incorporated together with Ti.

In the case of an Al—Co alloy, a target can be formed without being deformed even at a high temperature caused by high speed film formation by preparing an atomized powder of an alloy comprising AlCo, Al₅Co₂, Al₃Co, Al₁₃Co₄, Al₉Co₂, etc. and applying HIP such that the atomized powder and Co form an aimed alloy composition. By adding Co of an amount of from 18.1 at. % to 80.5 at. % to Al, an intermetallic compound having a melting point higher than that of Al having a low melting point can be formed. However, when Co of more than 58 at. % is added, the adhesion layer is magnetized in some cases, which is not preferred. It is preferable that Co of an amount of from 18.1 at. % to 58 at. % be added.

In the case of an Al—Cr alloy, a target can be formed without being deformed even at a high temperature caused by high speed film formation by preparing an atomized powder of an alloy comprising Al₄Cr, Al₉Cr₄, Al₈Cr₅, etc. and applying HIP such that the atomized powder and Cr form an aimed alloy composition. By adding Cr of an amount of from about 12.4 at. % to 42 at. % to Al, or adding Cr of an amount of from about 65.5 at % to 71.4 at. % to Al, an intermetallic compound having a melting point higher than that of Al can be formed. However, since the reliability is low within a range of Cr of the amount of from about 66.5 at. % to 71.4 at %, Cr of an additional amount of from 12.4 at. % to 42 at. % is preferably added to Al.

In the case of an Al—Hf alloy, a target can be formed without being deformed even at a high temperature caused by high speed film formation by preparing an atomized powder of an alloy comprising Al₃Hf, Al₂Hf, Al₃Hf₄, etc. and applying HIP such that the atomized powder and Hf form an aimed alloy composition. By adding Hf of an amount of from 25 at. % to 66.7 at. % to Al, an intermetallic compound having a melting point higher than that of Al can be formed. An alloy system containing Zr as an additive element may also be used.

In the case of an Al—Ni alloy, a target can be formed without being deformed even at a high temperature caused by high speed film formation by preparing an atomized powder of an alloy comprising Al₃Ni, Al₃Ni₂, AlNi etc. and applying HIP such that the atomized powder and Ni form an aimed alloy composition. By adding Ni of an amount of from 25 at. % to 77 at. % to Al, an intermetallic compound having a melting point higher than that of Al can be formed. However, when Ni of more than 75 at. % is added, a ferro-magnetic component of Ni appears in the adhesion layer and the adhesion layer is magnetized in some cases, which is not preferred. Ni of an amount of from 25. at. % to 75 at. % is preferably added to Al.

In the case of Al—Ta alloy, a target can be formed without being deformed even at a high temperature caused by high speed film formation by preparing an atomized powder of an alloy comprising Al₃Ta, Al₃Ta₂, AlTa, alTa₂, etc. and applying HIP to the atomized powder and Ta so as to form an aimed alloy composition. By adding Ta of an amount of from 25 at. % to 79 at. % to Al, an intermetallic compound having a melting point higher than that of Al can be formed.

In the case of Al—Zr alloy, a target can be formed without being deformed even at a high temperature caused by high speed film formation by preparing an atomized powder of an alloy comprising Al₃Zr, Al₂Zr, Al₃Zr₂, AlZr, etc. and applying HIP to the atomized powder and Zr so as to form an aimed alloy composition. By adding Zr of an amount of from 25 at. % to 75 at. % to Al, an intermetallic compound having a melting point higher than that of Al can be formed. Inevitable Hf may also be contained.

Since Sb is also a low-melting point material having a melting point of 630° C., it is preferred to be atomized with addition of an element for forming an intermetallic compound having a melting point higher than that of Sb. In the case of using Sb for the adhesion layer, when Co, Cr, Nb, Ti, Y, or Zr is selected as an additive, an intermetallic compound having a melting point higher than that of Sb having the low melting point can be constituted. The compositional range is to be described below.

In an Sb—Co system, Co of 46 at. % to 75 at. % may be added to Sb. In Sb alloy containing Sb of 43.5 at. % to 52.5 at. % forming the β-phase, since a ferromagnetic phase is sometimes deposited when Sb of 43.5 at. % to 46 at. % is added, Sb of 46 at. % or more is preferably added. The δ-phase is formed with Sb of 75 at. %. Accordingly, Sb of 46 at. % to 75 at. % is preferred since good adhesion can be obtained, Sb of 46 at. % forming the β-phase to 75, Sb of 75 at. % forming the δ-phase.

In an Sb—Cr system, a CrSb phase is formed with Sb of 47 at. % to 50 at. % Sb. Accordingly, Sb and Cr of 50 to 53 at. % is necessary.

In an Sb—Nb system, an intermetallic compound can be formed with the additional concentration of Nb up to 76 at. % with respect to Sb. Particularly, an NbSb phase formed with Sb of 50 to 51 at. % is preferred in view of good adhesion. Accordingly, an alloy consisting of Sb and Nb of 50 to 76 at. % is preferred.

In an Sb—Ti system, an intermetallic compound is obtained by the addition of Ti of 33.3 to 80 at. %, Ti of 33.3 at. % forming an Sb2Ti phase, Ti of 80 at. % forming an SbTi4 phase. Accordingly, an alloy of Sb and Ti of 33.3 to 80 at. % is preferred.

In an Sb—Y system, an intermetallic compound is obtained by the addition of Y of more than about 50 at. % and up to about 75 at. %, Y of more than 50 at. % forming an SbY phase, and Y of up to 75 at. % forming an SbY3 phase. That is, an alloy of Sb and Y of 50 to 70 at. % may be used.

In an Sb—Zr system, an intermetallic compound is obtained by the addition of Zr of more than about 33.3 at. % and up to about 75 at. %, Zr of more than about 33.3 at. % forming an Sb2Zr phase, Zr of up to 75 at. % forming an SbZr3 phase. That is, an alloy of Sb and Zr of 33.3 to 75 at. % may be used. Since the melting point is lowered when the Zr concentration is lower than the Zr concentration described above, which is not preferred, it is desirably about 33.3 at. % or more.

While the thickness of the non-magnetic under layer 102 can be increased to 10 nm or more, the reliability for sliding resistance is deteriorated in the case where it is excessively thick. On the other hand, in the case where the non-magnetic under layer 102 is not provided, adhesion strength to the substrate 101 is lowered. The thickness of the non-magnetic under layer 102 is preferably 3 nm or more and 10 nm or less since the adhesion strength is improved and the reliability for sliding resistance is improved.

As the substrate 101, a glass substrate more excellent in the surface smoothness or the impact resistance compared with an aluminum substrate is used. It may have 0.508 mm thickness and 48 mm diameter or 63.5 mm thickness and 65 mm diameter, and the diameter and the thickness of the substrate are not restricted. The substrate may be formed with a hole for clamping.

As the intermediate layers 106, 107, and 108, non-magnetic and amorphous alloys or alloys having a hexagonal close-packed structure or face-centered cubic lattice structure can be used. The intermediate layer may be a single layered film or may be a stacked film using materials of different crystal structures. The intermediate layer can suppress medium noises. In the case of using Ru having an hcp structure as the non-magnetic intermediate layer 107, an Ni—8 at. % W alloy film is preferably used as the intermediate layer 106 for highly orienting the C-axis of Ru.

For the perpendicular recording layer 109, the following artificial lattice films can be used: Co alloy films having an hcp structure such as of CoCrPt alloy and CoCrPtB alloy, granular films such as of CoCrPt—SiO₂, (Co/Pd) multi-layered films, (CoB/Pd) multi-layered films, (CoSi/Pd) multi-layered films, Co/Pt multi-layered films, (CoB/Pt) multi-layered films, (CoSi/Pt) multi-layered films, etc. It is preferable to use a structure of stacking a plurality of magnetic films having different properties of magnetic films of a granular structure and magnetic films of a non-granular structure, in which one layer of the granular structure contains cobalt, chromium, and platinum.

As the protective film 110 for the perpendicular recording layer, a DLC (Diamond Like Carbon) film mainly comprising carbon was formed. While it is preferred that the thickness of the protective layer 110 is thin in view of electromagnetic conversion characteristics, since the sliding resistance is deteriorated when the lubrication film is formed without providing the protective layer, it is desirably formed to a thickness, preferably, about from 3 nm to 4 nm. Further, a lubrication layer such as of perfluoro alkyl polyether is preferably used. This can provide a perpendicular magnetic recording medium of high reliability.

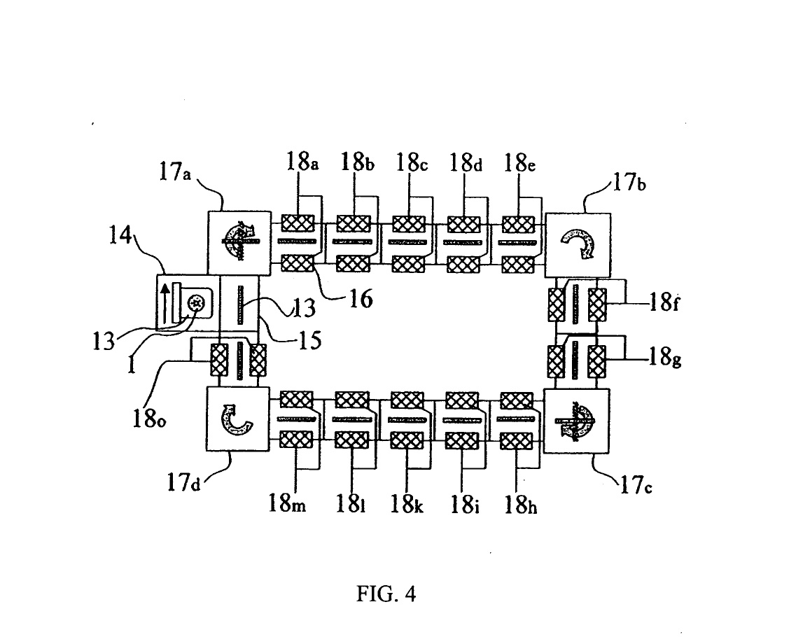

Then, a method of manufacturing the perpendicular recording medium is to be described. FIG. 4 shows an apparatus for manufacturing a perpendicular recording medium according to the present embodiment. The configuration of a multi-layered sputtering apparatus includes a holder 13 for holding and transferring a substrate 101, a load/unload chamber 15 having a mechanism for transferring the holder 13, corner chambers 17a to 17d each having a return mechanism for moving the holder 13, and process chambers 16 each having sputtering electrodes 18a to 18o each having a magnetic circuit and a sputtering power source and having an evacuating pump for partition with a gate valve and transportation. While the holder 13 holds the substrate 1 and the process chambers 16 are moved successively, each of the layers is formed. In this case, two of the sputtering electrodes 18 are disposed with both faces opposed to each other for each of the chambers. The holder mounting the substrate 101 is transported between the opposed sputter electrodes 18. Then, the holder mounting the substrate 101 is in a stationary state and a gas such as Ar is caused to flow from a process gas line provided with the process chamber 16. After a predetermined pressure is obtained, each of the layers is formed by sputtering. Upon film formation, all of the chambers are kept at a high vacuum state with the attainable vacuum degree being set to 2×10⁻⁵ Pa or less. Further, the pressure in the process chamber 16 during film formation is set within a range from 0.5 to 6 Pa. Further, as a sputtering system, a DC magnetron system of particularly high efficiency in sputtering is adopted. Typical metal and alloy sputtering, reactive sputtering, RF sputtering, pulse DC sputtering, etc. can be adopted.

In the film formation of the protective layer 110, it is formed by an RF-CVD method. In a state of adding a predetermined amount of hydrogen and nitrogen to an ethylene gas as a starting gas for conducting CVD, a protective layer 110 referred to as DLC is formed to the uppermost surface of the substrate by applying an RF power to the sputtering electrode 18o and applying a bias voltage to the substrate 101 by a substrate bias mechanism. 5 to 30% of hydrogen and 1 to 3% of a nitrogen gas were added to ethylene gas at a pressure kept at 2 to 3 Pa and a substrate bias voltage was controlled. In the present embodiment, production was conducted with 750 to 1200 media per one hour.

A sputtering target for forming the non-magnetic under layer was previously provided. It was prepared by conducting vacuum melting using a high-frequency induction furnace or using a levitation furnace for levitating a starting metal by a magnetic force of a high frequency current in an inert atmosphere and melting the same without contact with a side wall of a crucible, and using an alloy powder atomized by using an inert gas such as Ar. An alloy powder having melting point higher than that of Al or Sb containing an element M to be added to Al was previously prepared and an alloy powder classified into a size of about 150 μm was formed by sintering or HIP. HIP (Hot Isothermal Pressing method) is a technique of pressing treatment typically by utilizing a synergistic effect of a pressure of 100 MPa or higher and a temperature of 1000° C. or higher using an inert gas such as argon as a pressure medium, by which pressure can be applied to a powder from every direction uniformly. The average composition of the alloy powder to be atomized may be a composition of a high melting intermetallic compound adjacent to Al or Sb, or a target composition of an aimed composition.

As the substrate 101, a glass substrate of 0.508 mm thickness and 48 mm diameter was used. Heating was not applied for the substrate and the following thin film formation was conducted by a DC magnetron sputtering method under the condition at an Ar gas pressure of 0.5 Pa except for the non-magnetic intermediate layer 108 and the recording layer 109.

The non-magnetic under layer 102 was formed by using an alloy target of 5 nm thickness comprising Al—49.3 at. % Ti, 590 wt ppm Fe, 980 wt. ppm O, 130 wt. ppm C, and 110 wt. ppm N. The target was prepared by forming an atomized powder so as to be a 50 at. % Al—50 at. % Ti alloy and applying classification followed by HIP and had a density of 3.79. Further, an Ni—8 at. % W alloy film was formed to 8 nm as the non-magnetic intermediate layer 106, and Ru was formed by 8 nm as the non-magnetic intermediate layer 107. Ru was formed to 8 nm as the non-magnetic intermediate layer 108 and a Co—Cr—Pt—SiO₂ alloy was formed to 12 nm thickness as the recording layer 109 with an Ar gas pressure of 2 Pa upon formation.

Thin film formation was conducted under the condition at an Ar gas pressure of 0.5 Pa except for the non-magnetic intermediate layer 108 and the recording layer 109. While the electric discharge gas pressure is not restricted to 0.5 Pa, it is necessary to set the pressure for repeating electric discharge stably. The electric discharge gas pressure for the non-magnetic intermediate layer 107 is set lower than that for the non-magnetic intermediate layer 108 for orienting crystals of the non-magnetic intermediate layer 107 having the hcp structure along the c-axis in the direction normal to the film surface. The Ar gas pressure was set to 6 Pa upon forming Ru to 8 nm as the non-magnetic intermediate layer 108 for promoting the spatial separation of crystal grains by the self shadowing effect upon thin film formation thereby promoting the spatial separation of crystal grains constituting the recording layer 109 to be formed thereon. Since evacuation performance may sometimes be lowered in the case where the pressure is excessively high upon forming the non-magnetic intermediate layer 108, it is desirable to set a relatively high pressure compared with the electric discharge pressure upon forming the non-magnetic intermediate layer 107. For the formation of the recording layer, not only the DC magnetron sputtering method, but also a physical vapor deposition method such as a DC pulse sputtering method, an opposed target sputtering method, an RF magnetron sputtering method, or the like can be used. Use of the DC magnetron sputtering method is particularly preferred, since film formation by the sputtering method using radio frequency tends to increase grain size dispersion because of the large amount of heat generation.

Successively, after forming the protective layer 110 comprising carbon as the main component to 4 nm thickness by a chemical vapor deposition method, it was taken out into an atmospheric air to form a lubrication layer 111 containing a perfluoro polyether.

Based on the result of ICPS analysis on specimens in which the adhesion layer 101 was formed as a single layer, the composition of the metal constituent elements contained in the adhesion layer 101 substantially coincides with the composition of the targets for the specimens formed by using a target of the composition used the experimental example. However, since atomization is applied as has been described above, impurities of iron, oxygen, carbon, and nitrogen increased more than in usual sintered products.

The perpendicular recording media were mounted on a hard disk drive and, after heating at 60° C., they were exposed to a circumstance at a relative humidity of 85% for one week, and random seeking was continued. Subsequently, after reducing the relative humidity to 50%, the temperature was returned to a room temperature and the hard disk drive was decomposed. The surfaces of the taken out head and the perpendicular recording medium were put to surface observation and mapping observation for elements by a scanning electron microscope equipped with an energy dispersion type fluorescence X-ray analyzer. As a result, no remarkable changes such as discoloration were observed on the disk surface. Further, contamination due to aluminum, Ti, Ni, Ta, Cr, Zr, Co, and Hf considered to be attributable to the medium, was not observed on the slider surface of the head, which performed random seeking based on the result of the elemental analysis.

Targets for the layers other than the adhesion layer were formed by using HIP or vacuum melting from alloy powders formed by usual sintering without atomizing the metal alloy powders not forming the intermetallic compound. This can suppress the increase of the impurities such as oxygen and iron caused by atomization and can improve the productivity.

It is also possible to prepare alloy components of different concentrations, blending metal powders so as to obtain a desired average composition separately and applying HIP without directly forming an atomized powder of an aimed alloy target composition. That is, in the case of an Al—Ti alloy, a target can be formed without being deformed even at a high temperature caused by high speed film formation by previously preparing an atomized powder of a TiAl₃ alloy and applying HIP to the atomized powder and Ti so as to obtain a desired alloy composition.

Perpendicular magnetic recording media were formed in the same manner as described above except for forming the adhesion layers 102 of the following compositions.

Al—42 at. % Ni—500 wt.ppm Fe, Al—59 at. % Ni—450 wt.ppm Fe,

Al—50 at. % Ta—760 wt.ppm Fe, Al—75 at. % Ta—930 wt.ppm Fe,

Al—40 at. % Cr—480 wt.ppm Fe, Al—70 at. % Cr—320 wt.ppm Fe,

Al—30 at. % Zr—690 wt.ppm Fe, Al—50 at. % Zr—1060 wt.ppm Fe,

Al—30 at. % Co—300 wt.ppm Fe, Al—55 at. % Co—530 wt.ppm Fe,

Al—37 at. % Hf—890 wt.ppm Fe, Al—28 at. % Hf—740 wt.ppm Fe,

Sb—44 at. % Co—400 wt.ppm Fe, Sb—75 at. % Co—450 wt.ppm Fe,

Sb—47 at. % Cr—690 wt.ppm Fe, Sb—50 at. % Cr—730 wt.ppm Fe,

Sb—24 at. % Nb—450 wt.ppm Fe, Sb—50 at. % Nb—650 wt.ppm Fe,

Sb—34 at. % Ti—750 wt.ppm Fe, Sb—79 at. % Ti—890 wt.ppm Fe,

Sb—53 at. % Y—820 wt.ppm Fe, Sb—75 at. % Y—920 wt.ppm Fe,

Sb—34 at. % Zr—580 wt.ppm Fe, Sb—74 at. % Zr—790 wt.ppm Fe.

As a result of mounting the perpendicular recording media on the same hard disk drive as in the embodiment described above and conducting evaluation, no remarkable changes such as discoloration were observed on the disk surface, and contamination caused by aluminum, antimony, Ni, Ta, Cr, Zr, Co, Hf, Nb, Ti, and Y considered to be attributable to the media, was not observed on the slider surface of the magnetic head which performed random seeking based on the result of elemental analysis.

### SECOND EMBODIMENT

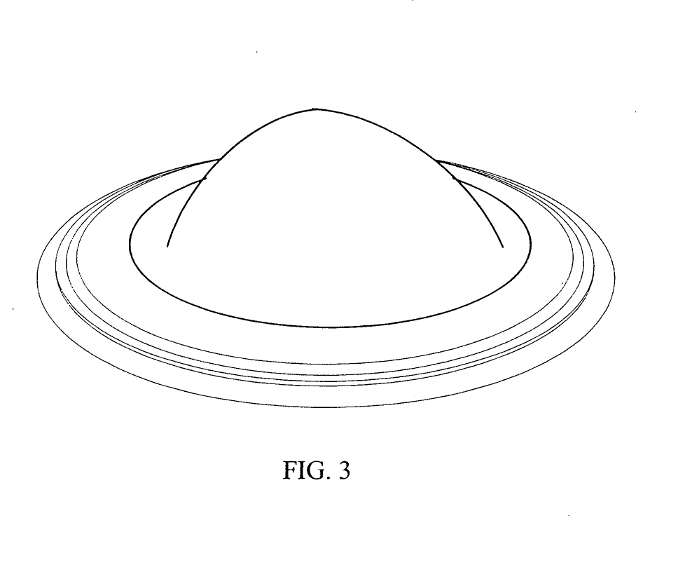

FIG. 2 is a cross-sectional view showing the structure of a perpendicular magnetic recording medium according to a second embodiment of the present invention. A perpendicular magnetic recording medium 100 has, on a substrate 101, a non-magnetic under layer 102, a soft magnetic under layer 103, a non-magnetic layer 104, a soft magnetic under layer 105, a non-magnetic intermediate layers 106, 107, and 108, a recording layer 109, a protective layer 110, and a lubrication layer 111. This corresponds to a constitutional example of adding a soft magnetic under layer in the perpendicular recording media of the first embodiment. This facilitates magnetization recording perpendicular to the medium. The medium according to the present embodiment has a structure of putting a non-magnetic layer between the soft magnetic under layers to conduct anti-ferromagnetic coupling between the two soft magnetic under layers.

The non-magnetic layer 104 formed between the first soft magnetic layer 103 and the second soft magnetic layer 105 has a function of anti-ferromagnetically coupling the first soft magnetic layer 103 and the second magnetic layer 105. As the material used for the non-magnetic layer, it is preferred to use Ru or Cu in the case of using an amorphous alloy comprising Co as a main component for both of the soft magnetic layers and use Cr or Ru in the case of using an amorphous alloy comprising Fe as a main component for both of the soft magnetic layers. For example, it is also possible to use an alloy comprising Ru or an alloy comprising Ru as a main component, for example, an RuFe alloy. Generally, it is preferred to set the thickness of the non-magnetic layer 104 as from 0.5 nm to 0.8 nm thickness in the case of using an alloy containing Ru or an alloy comprising Ru as a main component so as to make anti-ferromagnetic coupling larger.

It may be desirable for the first soft magnetic layer 103 and the second soft magnetic layer 105 to use materials having high permeability and capable of providing anti-corrosion reliability such as a magnetic layer containing Co, Ta and Zr, or a magnetic layer containing Fe, Co, Ta and Zr. It may be desirable that a product of the residual magnetic flux density and the film thickness is substantially equal between the soft magnetic layers 103 and 105, and the product is at a level capable of anti-ferromagnetic coupling by way of the non-magnetic layers 104. To suppress the noises due to the residual magnetization in the soft magnetic under layer after anti-ferromagnetic coupling of the soft magnetic under layer and determination of the magnetized state of the upper recording layer, it is particularly preferred that an alloy film containing a 51 at. % Fe, 34 at. % Co, 10 at. % Ta and 5 at. % Zr and having a thickness of 30 nm is formed as the soft magnetic layer 103, and an Ru film of 0.7 nm thickness is formed as the non-magnetic layer 104 and then an alloy film containing 51 at. % Fe, 34 at. % Co, 10 at. % Ta, and 5 at. % Zr and having a thickness of 30 nm is formed again as the soft magnetic under layer 105.

By adding the soft magnetic under layer, magnetic fluxes can flow easily in the direction perpendicular to the disk surface, and thickness of the medium increases. Particularly, in the case of using an AFC soft magnetic under layer, since the thickness of the soft magnetic under layer is from several nm to several hundreds nm, planarity of the soft magnetic under layer is deteriorated, thereby worsening the scratch resistance. In view of the above, a further uniformness is required for the adhesion layer 102 formed as a thin film under the soft magnetic under layer. Deterioration of the film quality caused by the deformation of the target gives an undesired effect on the reliability. Then, the deformation of the target has to be suppressed further.

Further, the adhesion is improved by using the constituent element Al or Sb as the low-melting point material for the non-magnetic under layer, because the contained alloy component having a low melting point latently facilitates formation of the intermetallic compound and because the surface at the boundary with the substrate 101 or the non-magnetic intermediate layer 106 is active thereby improving the adhesion strength.

Then, a method of manufacturing the perpendicular recording medium 200 is to be described.

For the substrate 101, a glass substrate of 0.508 mm thickness and 48 mm diameter was used. A DC magnetron sputtering apparatus was used and after evacuating all the chambers to a vacuum of 2×10⁻⁵ Pa or lower, without heating the substrate 101, a carrier mounting the substrate 101 was moved to each of the process chambers, to conduct the following thin film formation under the condition at an Ar gas pressure of 0.5 Pa except for the non-magnetic intermediate layer 108 and the recording layer 109. The electric discharge gas pressure was set to 2 Pa upon forming the non-magnetic intermediate layer 108 and the recording layer 109.

An alloy film of Al, Ti of 50 at. % and Fe of 300 wt.ppm was formed with a thickness of 5 nm as the non-magnetic under layer 102. An alloy film of 51 at. % Fe, 34 at. % Co, 10 at. % Ta, and 5 at. % Zr was formed with a thickness of 30 nm as the soft magnetic layer 103, and an Ru film of 0.7 nm thickness was formed as the non-magnetic layer 104, and then an alloy film of 51 at. % Fe, 34 at. % Co, 10 at. % Ta, 5 at. % Zr was again formed with a thickness of 30 nm as the soft magnetic under layer 105. Cooling of the substrate by using a gas such as helium for heat exchange after forming the soft magnetic under layer 105 is preferred for reducing the grain size dispersion of the recording layer 109 to be formed subsequently.

An alloy film of Ni and 8 at. % W was formed with a thickness of 8 nm as the non-magnetic intermediate layer 106 and Ru was formed with a thickness of 8 nm as the non-magnetic intermediate layer 107. In the case of forming Ru with a thickness of 8 nm as the non-magnetic intermediate layer 108, an Ar gas pressure was set to 2 Pa.

Subsequently, a Co—Cr—Pt—SiO₂ alloy was prepared so as to be 12 nm thickness as the recording layer 109.

Successively, after forming the protective layer 110 comprising carbon as the main component to 4 nm thickness by a chemical vapor deposition method, it was taken out in an atmospheric air to form the lubrication layer 111 containing perfluoropolyether.

Based on the result of ICPS analysis on the specimens forming the adhesion layer 101 with a single layer, the composition of the adhesion layer 101 substantially coincided with the composition of the targets for the specimens using targets of any compositions used in the experimental example.

As a result of mounting the perpendicular recording media on the same hard disk as in the example described above and conducting the same evaluation, no remarkable changes such as discoloration were recognized on the disk surface. Further, contamination caused by aluminum, Ni, Ta, Cr, Zr, Co, and Hf considered to be attributable to the medium was not observed from the result of the elemental analysis on the slider surface of the magnetic head which performed random seeking.

While description has been made to examples of using targets of atomized alloy powders for the formation of the adhesion layer using low melting point, it is possible to suppress the deformation of targets also in other layers by forming the intermetallic compounds by atomization and using them for sputtering.

What is claimed is:

1. A perpendicular magnetic recording medium, comprising:
a substrate;
an adhesion layer;
an intermediate layer;
a perpendicular recording layer; and
a protective layer;
wherein the adhesion layer disposed between the intermediate layer and the substrate is formed by sputtering an alloy powder containing an intermetallic compound; and
the alloy powder is formed of two or more of metal elements having different melting points from each other, and has a melting point higher than that of a metal element having the lowest melting point among the two or more of metal elements having different melting points from each other.

2. The perpendicular magnetic recording medium according to claim 1, further comprising a soft magnetic layer disposed between the intermediate layer and the adhesion layer.

3. The perpendicular magnetic recording medium according to claim 2, wherein
the adhesion layer contains Al and at least one or more of metal elements in the group consisting of Ti, Ni, Ta, Cr, Zr, Co, and Hf.

4. The perpendicular magnetic recording medium according to claim 3, wherein
the adhesion layer contains oxygen and iron as an impurity; and
the lowest melting point is 660° C. or lower.

5. The perpendicular magnetic recording medium according to claim 2, wherein
the adhesion layer contains Sb and at least one or more of metal elements in the group consisting of Ti, Nb, Cr, Zr, Co and Y.

6. The perpendicular magnetic recording medium according to claim 5, wherein
the adhesion layer contains oxygen and iron of 300 wt.ppm or more.

7. The perpendicular magnetic recording medium according to claim 2, wherein
the adhesion layer has a thickness of more than 3 nm and 10 nm or less.

8. The perpendicular magnetic recording medium according to claim 2, wherein
the soft magnetic layer has first and second soft magnetic layers and a non-magnetic layer disposed between the first and the second soft magnetic layers, and
the perpendicular magnetic recording layer comprises a plurality of layers.

9. The perpendicular magnetic recording medium according to claim 8, wherein
the first and the second soft magnetic layers contain Fe, Co, Ta, and Zr;
the non-magnetic layer contains Ru; and
at least one of the perpendicular recording layers contains cobalt, chromium, and platinum, and has a granular structure.

10. A method of manufacturing a perpendicular magnetic recording medium, the method comprising the steps of;
forming a non-magnetic under layer on a substrate by sputtering;
forming an intermediate layer on the non-magnetic under layer;
forming a recording layer on the intermediate layer; and
forming a protective layer on the recording layer, wherein
an intermetallic compound having a melting point higher than that of a first metal element formed by atomizing first and second metal elements having different melting points from each other is used as a target in the step of forming the non-magnetic under layer, and the melting point of the first metal element is lower than the melting point of the second metal element.

11. The method of manufacturing a perpendicular magnetic recording medium according to claim 10, the method further comprising;
forming a soft magnetic layer between the non-magnetic under layer and the intermediate layer, wherein
the soft magnetic layer has a first and second soft magnetic layers and a non-magnetic layer disposed between the first and second soft magnetic layers.

12. The method of manufacturing a perpendicular magnetic recording medium according to claim 11, wherein
the soft magnetic layer, the intermediate layer, and the recording layer are formed by sputtering and an alloy powder not constituting the intermetallic compound is used for respective targets.

13. The method of manufacturing a perpendicular magnetic recording medium according to claim 10, wherein
the first metal element is Al, and
the second metal element is one of Ti, Ni, Ta, Cr, Zr, Co, and Hf.

14. The method of manufacturing a perpendicular magnetic recording medium according to claim 10, wherein
the first metal element is Sb, and
the second metal element is one of Ti, Nb, Cr, Zr, Co, and Y.

15. The method of manufacturing a perpendicular magnetic recording medium according to claim 11, wherein
the non-magnetic layer contains Ru,
the non-magnetic layer has a thickness of more than 3 nm and 10 nm or less and has a function of attaching the soft magnetic layer and the substrate.

16. The method of manufacturing a perpendicular magnetic recording medium according to claim 11, wherein
the melting point of the first metal element is 660° C. or lower.

17. The method of manufacturing a perpendicular magnetic recording medium according to claim 11, wherein
the target subjected to HIP after atomization is used.

18. The method of manufacturing a perpendicular magnetic recording medium according to claim 11, wherein
the first and the second soft magnetic layers contain Fe, Co, Ta, and Zr;
the non-magnetic layer contains Ru; and
the recording layer has a plurality of layers, and one of the plurality of layers contains cobalt, chromium and platinum and has a granular structure.

19. A perpendicular magnetic recording medium, comprising:
a substrate;
an adhesion layer;
first and second soft magnetic layers anti-ferromagnetically coupled by way of a non-magnetic layer;
a non-magnetic layer;
a second soft magnetic layer;
an intermediate layer;
a perpendicular recording layer; and
a protective layer;
wherein the adhesion layer is disposed between the first soft magnetic layer and the substrate; and
the adhesion layer contains Al, oxygen, iron of 300 wt.ppm or more, and at least one or more of metal elements in the group consisting of Ti, Ni, Ta, Cr, Zr, Co, and Hf.

20. The perpendicular magnetic recording medium according to claim 19, wherein
the first and the second soft magnetic layers contain Fe, Co, Ta, and Zr;
the non-magnetic layer contains Ru; and
at least one of the perpendicular recording layers contains cobalt, chromium, and platinum, and has a granular structure.
